(19) United States
(12) Patent Application Publication
(10) Pub. No.: US 2022/0123481 A1
(43) Pub. Date: Apr. 21, 2022

(54) ANTENNA DEVICE

(71) Applicant: Tyco Electronics AMP Korea Co., Ltd., Jillyang-Eup Gyeongsan (KR)

(72) Inventors: Jung-Hoon Kim, Suwon (KR); Chang Hyun Lee, Suwon (KR)

(21) Appl. No.: 17/504,723

(22) Filed: Oct. 19, 2021

(30) Foreign Application Priority Data
Oct. 21, 2020 (KR) 10-2020-0136772

(51) Int. Cl. H01Q 21/12; H01Q 1/42

(52) U.S. Cl. CPC H01Q 21/12; H01Q 1/422

(57) ABSTRACT

Disclosed is an antenna device. The antenna device includes a first conductor pattern including a plurality of first antenna components, the first conductor pattern formed on a first substrate, a second conductor pattern including a plurality of second antenna components, the second conductor pattern formed on a second substrate, and a plurality of conductor lines connecting each of the first antenna components of the first conductor pattern and each of the second antenna components of the second conductor pattern, wherein the first conductor pattern and the second conductor pattern may be spaced apart from each other.

### CROSS REFERENCE TO RELATED APPLICATIONS

This application claims priority to KR Application No. 10-2020-0136772, filed 2020 Oct. 21, the subject matter of which is herein incorporated by reference in its entirety.

### BACKGROUND

One or more example embodiments relate to an antenna device.

An antenna is a component made of a conductor that radiates or receives radio waves to or from other places to achieve the purpose of communication in wireless communication, and may be used in various products such as wireless telegraphs, wireless telephones, radios, and televisions.

The recent market requires very wide and diverse ranges of communication frequencies. The magnetic resonance frequency of a helical antenna, which is a well-known type of antenna, depends on a conductor pattern length, a conductor pattern diameter, and a spacing of screws. Although the relationship between the length of an antenna and the frequency is known, an antenna has a physically fixed length and shape and thus, it is difficult to support wide (multiple) bands (frequencies). Therefore, different antennas are required respectively for frequency bands to satisfy market demand. Accordingly, it takes time and cost to develop the antennas.

### BRIEF DESCRIPTION

According to an aspect, there is provided an antenna device including a first conductor pattern including a plurality of first antenna components, the first conductor pattern formed on a first substrate, a second conductor pattern including a plurality of second antenna components, the second conductor pattern formed on a second substrate, and a plurality of conductor lines connecting each of the first antenna components of the first conductor pattern and each of the second antenna components of the second conductor pattern, wherein the first conductor pattern and the second conductor pattern may be spaced apart from each other.

The first conductor pattern may be formed such that the plurality of first antenna components are formed on the first substrate in a diagonal direction and arranged in parallel at intervals.

The second conductor pattern may be formed such that the plurality of second antenna components are formed on the second substrate in a direction different from the direction in which the plurality of first antenna components are formed, and arranged in parallel at intervals.

The second conductor pattern may be formed such that the plurality of second antenna components are arranged in parallel in a vertical direction.

Each of the plurality of conductor lines may connect a first end point of each of the plurality of first antenna components and a first end point of each of the plurality of second antenna components, or connect a second end point of each of the plurality of first antenna components and a second end point of another second antenna component adjacent to the second antenna component with the first end point connected.

A communication frequency of the antenna device may be controlled by adjusting the number of second antenna components directly connected to each other among the second antenna components.

The communication frequency of the antenna device may increase as the number of second antenna components directly connected to each other increases.

The antenna device may further include a third substrate including an attachment region and a ground region, wherein both end points of each of the plurality of second antenna components of the second substrate may be attached to the attachment region.

The third substrate may further include a feed point connected to one of the end points of each of the plurality of second antenna components attached to the third substrate to supply power thereto, and a matching component pad connected to the feed point to adjust impedance.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a perspective view illustrating an antenna device according to an example embodiment;

FIGS. 2A and 2B illustrate a first substrate and a second substrate of an antenna device according to an example embodiment;

FIG. 3 illustrates an antenna device and additional elements according to an example embodiment;

FIG. 4 illustrates the characteristics of a helical antenna according to a related art;

FIG. 5 illustrates an azimuth plane and an elevation plane of an antenna device according to an example embodiment;

FIG. 6A illustrates the characteristics of an antenna device according to an example embodiment;

FIG. 6B shows a VSWR of a communication frequency band of the antenna device in FIG. 6A;

FIG. 6C shows an antenna device radiation pattern of the azimuth plane of the antenna device in FIG. 6A;

FIG. 6D shows an antenna device radiation pattern of the elevation plane of the antenna device in FIG. 6A;

FIG. 6E shows a radiation efficiency of the communication frequency band of the antenna device in FIG. 6A;

FIG. 7A illustrates the characteristics of an antenna device according to another example embodiment;

FIG. 7B shows a VSWR of a communication frequency band of the antenna device in FIG. 7A;

FIG. 7C shows an antenna device radiation pattern of the azimuth plane of the antenna device in FIG. 7A;

FIG. 7D shows an antenna device radiation pattern of the elevation plane of the antenna device in FIG. 7A;

FIG. 7E shows a radiation efficiency of the communication frequency band of the antenna device in FIG. 7A;

FIG. 8A illustrates the characteristics of an antenna device according to still another example embodiment; and

FIG. 8B shows a VSWR of a communication frequency band of the antenna device in FIG. 8A;

FIG. 8C shows an antenna device radiation pattern of the azimuth plane of the antenna device in FIG. 8A;

FIG. 8D shows an antenna device radiation pattern of the elevation plane of the antenna device in FIG. 8A;

FIG. 8E shows a radiation efficiency of the communication frequency band of the antenna device in FIG. 8A;

FIG. 9A illustrates the antenna device according to yet another example embodiment;

FIG. 9B shows a VSWR of a communication frequency band of the antenna device in FIG. 9A;

FIG. 9C shows an antenna device radiation pattern of the azimuth plane of the antenna device in FIG. 9A;

FIG. 9D shows an antenna device radiation pattern of the elevation plane of the antenna device in FIG. 9A;

FIG. 9E shows a radiation efficiency of the communication frequency band of the antenna device in FIG. 9A.

### DETAILED DESCRIPTION

The following detailed structural or functional description is provided as an example only and various alterations and modifications may be made to the examples. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples will be described in detail with reference to the accompanying drawings. When describing the examples with reference to the accompanying drawings, like reference numerals refer to like constituent elements and a repeated description related thereto will be omitted.

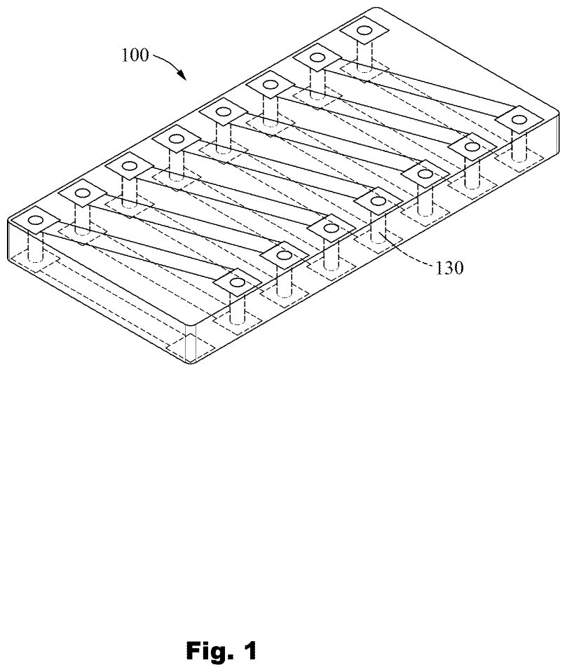

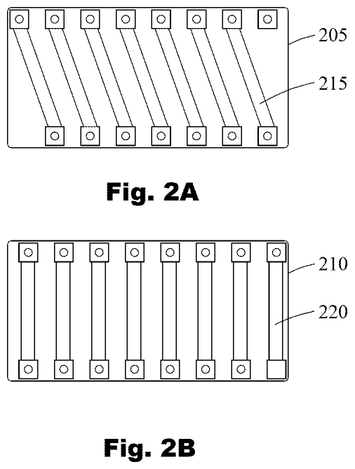

FIG. 1 is a perspective view illustrating an antenna device according to an example embodiment, FIGS. 2A and 2B illustrate a first substrate and a second substrate of the antenna device according to an example embodiment.

Referring to FIGS. 1, 2A and 2B, an antenna device 100 may include a first substrate 205 including a first conductor pattern formed of a plurality of first antenna components 215, and a second substrate 210 including a second conductor pattern formed of a plurality of second antenna components 220. The first conductor pattern may be formed such that the plurality of first antenna components 215 may be formed in a diagonal direction and arranged in parallel at intervals. The second conductor pattern may be formed such that the plurality of second antenna components 220 may be formed in a direction different from the direction in which the plurality of first antenna components 215 are formed, and arranged in parallel at intervals. The second conductor pattern may be formed such that the plurality of second antenna components 220 may be arranged in parallel in a vertical direction.

The first substrate 205 including the first conductor pattern and the second substrate 210 including the second conductor pattern may be vertically disposed while being spaced apart from each other. The antenna device 100 may include a plurality of conductor lines 130 connecting each of the first antenna components 215 of the first conductor pattern and each of the second antenna components 220 of the second conductor pattern in the space therebetween. Each of the plurality of conductor lines 130 may connect a first end point of each of the plurality of first antenna components 215 and a first end point of each of the plurality of second antenna components 220, or connect a second end point of each of the plurality of first antenna components 215 and a second end point of another second antenna component 220 adjacent to the second antenna component 220 with the first end point connected.

As the first conductor pattern and the second conductor pattern are connected through the conductor lines 130, the antenna device 100 may be formed and function similar to a helical antenna.

The structure of the antenna device 100 may be manufactured using a printed circuit board (PCB). However, example embodiments are not limited thereto. Various substrates may be adopted, as necessary. Unlike the existing helical antennas, the antenna device 100 may not require a mold and may be manufactured using surface mount technology (SMT) and thus, may be easily manufactured compared to the existing helical antennas.

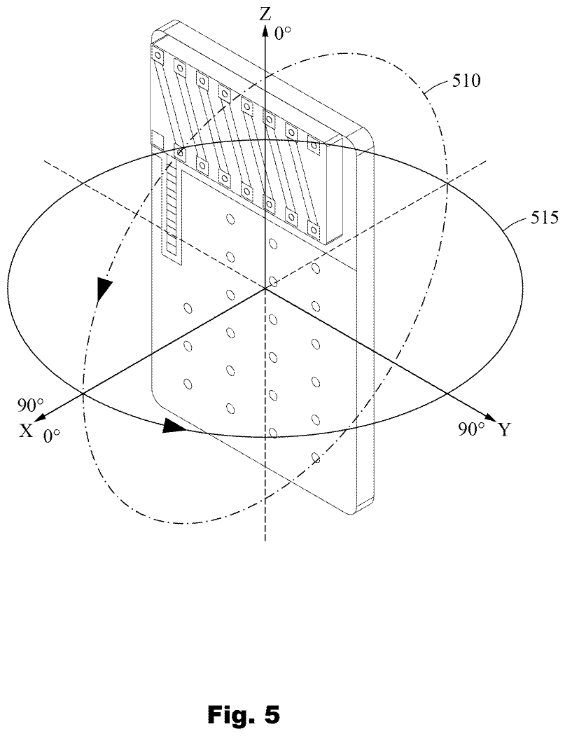

As mentioned above, an antenna has a physically fixed length and shape, and thus it is difficult to support wide (multiple) bands (frequencies). However, in the antenna device 100, an effect like adjusting the antenna length may be achieved by directly connecting the plurality of second antenna components 220, and a communication frequency may be easily controlled by adjusting the number of second antenna components 220 directly connected to each other among the plurality of second antenna components 220. As the number of second antenna components 220 directly connected to each other increases, the antenna length decreases, and the communication frequency (or band) of the antenna device 100 increases. Through this, the antenna device 100 may support communication in diverse frequency ranges using a single antenna on a PCB by changing the physical length of the antenna. This will be described further below with reference to FIGS. 5 to 9.

By adjusting the number of second antenna components 220 directly connected to each other in the antenna device 100, maximum performance may be supported for a target frequency suitable for the purpose of using the antenna. Further, the resonance frequency may be easily and selectively controlled within a specific frequency range without changing the antenna, whereby the cost for the antenna may be reduced.

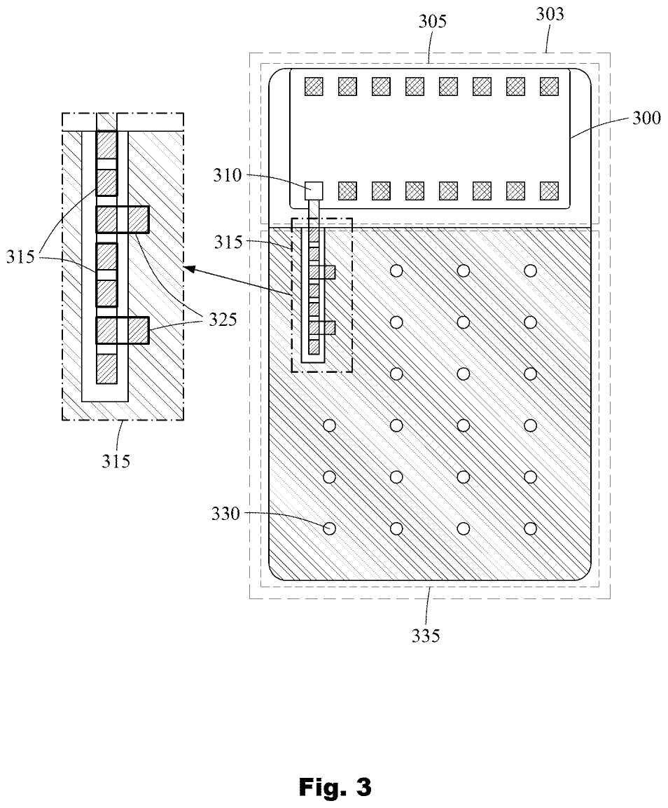

FIG. 3 illustrates an antenna device and additional elements according to an example embodiment.

Referring to FIG. 3, a third substrate 303 including an attachment region 305 and a ground region 335, and an antenna device 300 attached to the attachment region 305 of the third substrate 303 are illustrated. The antenna device 300 may correspond to the antenna device 100. The antenna device 300 may be attached to the attachment region 305 of the third substrate 303. In this case, both end points of each of the plurality of second antenna components 220 of the second substrate 210 may be connected to the third substrate 303. The third substrate 303 may be manufactured using a PCB. However, example embodiments are not limited thereto. Various substrates may be adopted, as necessary. To improve the antenna performance, a copper component such as copper foil may not be included in the attachment region 305, except for the antenna device 300.

The third substrate 303 may include a feed point 310 connected to one of the end points of the plurality of second antenna components 220 attached to the third substrate 303 to supply power thereto. The feed point 310 may be connected to one of both end points of an outermost second antenna component 220 among the second antenna components 220. The third substrate 303 may further include a matching component pad 315 connected to the feed point 310. The matching component pad 315 may include a shunt component pad 325 and a series component pad 320 for impedance control. The third substrate 303 may include the ground region 335 formed in a portion other than the attachment region 305, and a plurality of ground vias 330.

By directly connecting the second antenna components 220 attached to the third substrate 303, the antenna length may be adjusted, and the resonance frequency may be controlled. As mentioned above, the resonance frequency may increase as the number of second antenna components 220 directly connected to each other increases.

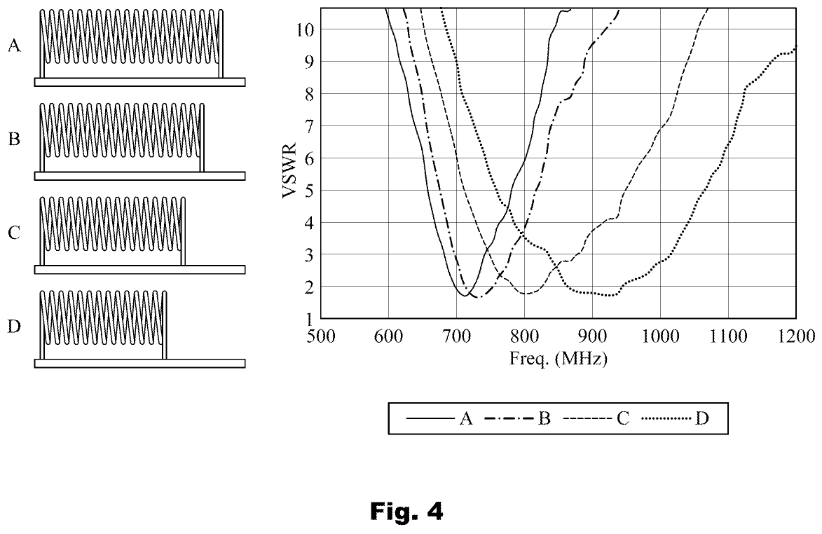

FIG. 4 illustrates the characteristics of a helical antenna according to a related art.

Referring to FIG. 4, a communication band changing in response to a change in the length of a helical antenna according to the related art is shown. In FIG. 4, Cases A to D show lengths of a conventional helical antenna, and each graph shows the relationship between a voltage standing wave ratio (VSWR) and a frequency in each case. It may be seen that the length of the helical antenna decreases in an order from Case A to Case D, and the communication band increases as the length of the helical antenna decreases. To change the communication band of the existing helical antenna as shown in FIG. 4, the physical length of the antenna should be changed.

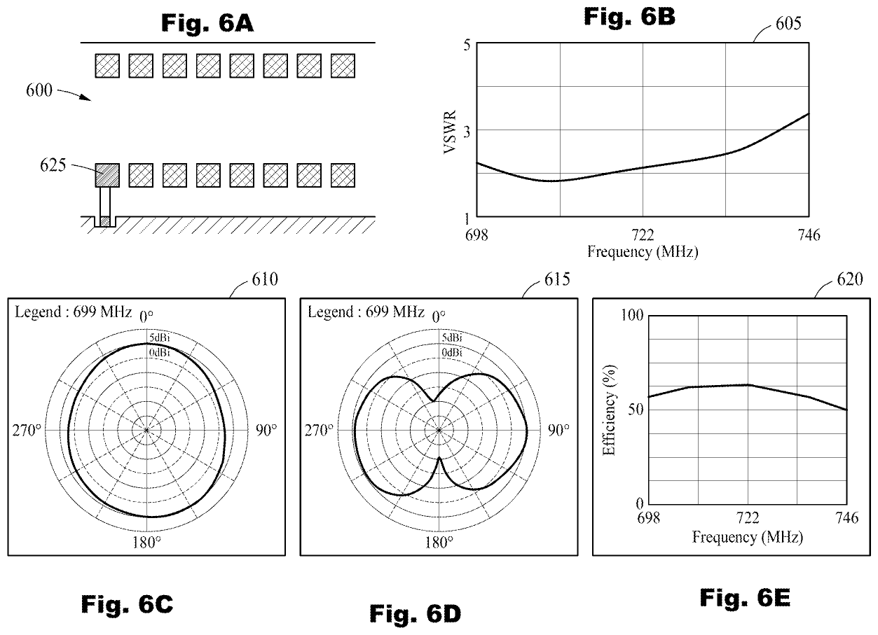

FIG. 5 illustrates an azimuth plane 510 and an elevation plane 515 of an antenna device according to an example embodiment, and FIGS. 6 through 9 illustrate examples of selecting a communication band by connecting a plurality of second antenna components of a second conductor pattern attached to a third substrate. In the antenna device 100, a specific band may be selected within a specific range of frequency bands. For example, the antenna device 100 may support a communication band of 698 MHz to 960 MHz to support a low frequency used for NB-IoT products. The communication band may be selected by connecting a plurality of second antenna components in the band of 698 MHz to 960 MHz supported by the antenna device 100. The communication band supported by the antenna device 100 is not limited thereto, and other communication bands may be supported, as necessary, by adjusting the antenna device 100, the ground region, the matching component pad, and the like.

In the antenna device 100, the communication frequency may be easily changed without changing the antenna device 100. Relatively diverse communication bands may be obtained by changing the antenna length using a single antenna device 100. When the antenna device 100 is used, it is possible to apply a relatively wide communication band with the same structure and the same cost to satisfy the market demand and to increase design freedom.

Referring to FIGS. 5 and 6A-6E, a resonance frequency band and characteristics of an antenna device according to an example embodiment are shown. An antenna device 600 is attached to a third substrate as shown in FIG. 5 and fed through a feed point 625. The antenna device 600 is shown in FIG. 6A and may correspond to the antenna device 100. Second antenna components of the antenna device 600 are not directly connected to each other. FIG. 6B shows a VSWR 605 of a communication frequency band. FIG. 6C shows an antenna device radiation pattern 610 of the azimuth plane 510. FIG. 6D shows an antenna device radiation pattern 615 of the elevation plane 515. FIG. 6E shows a radiation efficiency 620 of the communication frequency band. It may be seen that if the second antenna components of the antenna device 600 are not directly connected to each other, the communication band is formed around 722 MHz within the band of 698 MHz to 960 MHz supported by the antenna device 600.

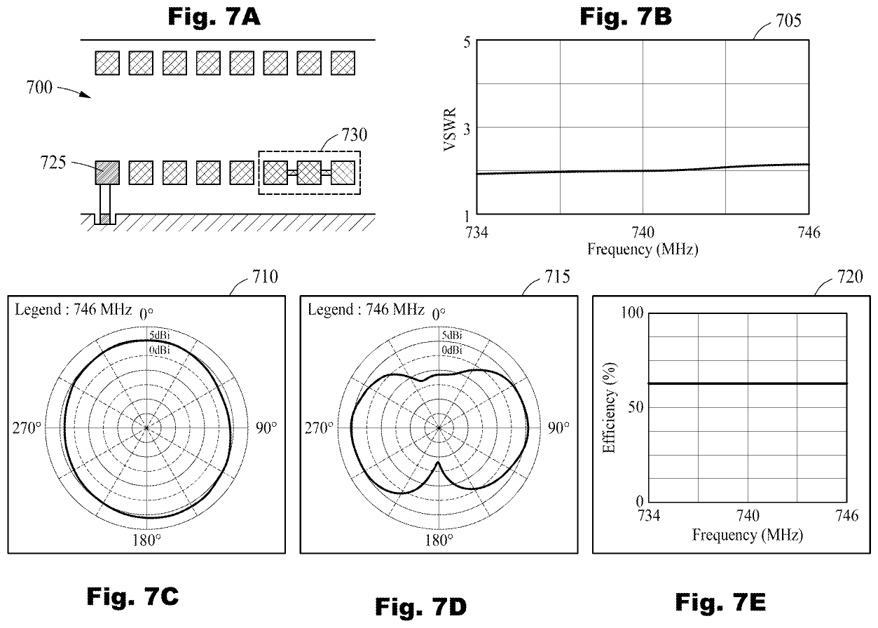

Referring to FIGS. 5 and 7, a resonance frequency band and characteristics of an antenna device according to another example embodiment are shown. An antenna device 700 is attached to a third substrate as shown in FIG. 5 and fed through a feed point 725. The antenna device 700 is shown in FIG. 7A and may correspond to the antenna device 100. In a region 730, three of second antenna components of the antenna device 700 are directly connected to each other. The second antenna components may be connected to each other on the third substrate to which the second antenna components are connected. FIG. 7B shows a VSWR 705 of a communication frequency band. FIG. 7C shows an antenna device radiation pattern 710 of the azimuth plane 510. FIG. 7D shows an antenna device radiation pattern 715 of the elevation plane 515. FIG. 7E shows a radiation efficiency 720 of the communication frequency band. It may be seen that if three of the second antenna components of the antenna device 700 are directly connected to each other, the communication band is formed around 740 MHz within the band of 698 MHz to 960 MHz supported by the antenna device 700.

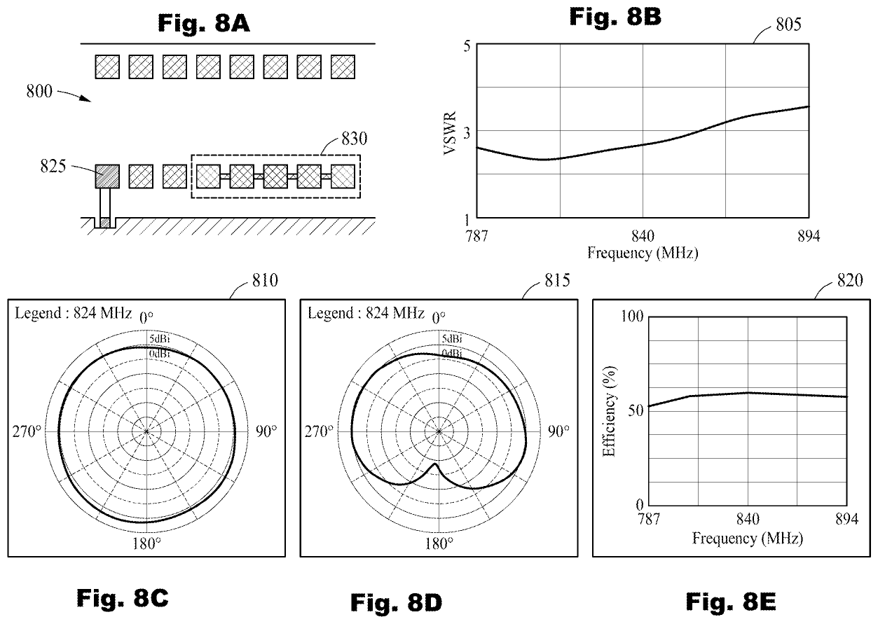

Referring to FIGS. 5 and 8, a resonance frequency band and characteristics of an antenna device according to still another example embodiment are shown. An antenna device 800 is attached to a third substrate as shown in FIG. 5 and fed through a feed point 825. The antenna device 800 is shown in FIG. 8A and may correspond to the antenna device 100. In a region 830, five of second antenna components of the antenna device 800 are directly connected to each other. The second antenna components may be connected to each other on the third substrate to which the second antenna components are connected. FIG. 8B shows a VSWR 805 of a communication frequency band. FIG. 8C shows an antenna device radiation pattern 810 of the azimuth plane 510. FIG. 8D shows an antenna device radiation pattern 815 of the elevation plane 515. FIG. 8E shows a radiation efficiency 820 of the communication frequency band. It may be seen that if five of the second antenna components of the antenna device 800 are directly connected to each other, the communication band is formed around 840 MHz within the band of 698 MHz to 960 MHz supported by the antenna device 800.

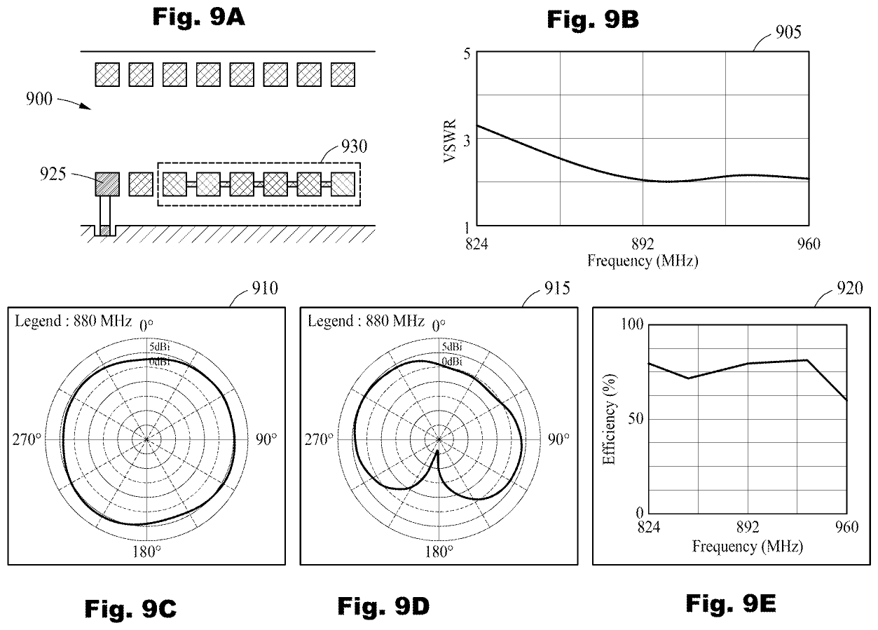

Referring to FIGS. 5 and 9, a resonance frequency band and characteristics of an antenna device according to yet another example embodiment are shown. An antenna device 900 is attached to a third substrate as shown in FIG. 5 and fed through a feed point 925. The antenna device 900 is shown in FIG. 9A and may correspond to the antenna device 100. In a region 930, six of second antenna components of the antenna device 900 are directly connected to each other. The second antenna components may be connected to each other on the third substrate to which the second antenna components are connected. FIG. 9B shows a VSWR 905 of a communication frequency band. FIG. 9C shows an antenna device radiation pattern 910 of the azimuth plane 510. FIG. 9D shows an antenna device radiation pattern 915 of the elevation plane 515. FIG. 9E shows a radiation efficiency 920 of the communication frequency band. It may be seen that if six of the second antenna components of the antenna device 900 are directly connected to each other, the communication band is formed around 892 MHz within the band of 698 MHz to 960 MHz supported by the antenna device 900.

The results shown in FIGS. 6 to 9 are obtained according to example embodiments. It is obvious to those skilled in the art that the antenna radiation characteristics may be controlled by adjusting the number of second antenna components directly connected to each other, the length of the ground region, and the configuration of the matching component pad based on the obtained results. The number of second antenna components directly connected to each other may be 3, 5, 6, or may be adjusted differently, as necessary. Further, the characteristics of the communication band may be changed not only by adjusting the number of second antenna components directly connected to each other, but also by controlling the length of the ground region of the third substrate and the configuration of the matching component pad. For example, the radiation efficiency may be increased by increasing the length of the ground region.

A number of example embodiments have been described above. Nevertheless, it should be understood that various modifications may be made to these embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. An antenna device, comprising:
a first conductor pattern comprising a plurality of first antenna components, the first conductor pattern formed on a first substrate;
a second conductor pattern comprising a plurality of second antenna components, the second conductor pattern formed on a second substrate; and
a plurality of conductor lines connecting each of the first antenna components of the first conductor pattern and each of the second antenna components of the second conductor pattern,
wherein the first conductor pattern and the second conductor pattern are spaced apart from each other.

2. The antenna device of claim 1, wherein the first conductor pattern is formed such that the plurality of first antenna components are formed on the first substrate in a diagonal direction and arranged in parallel at intervals.

3. The antenna device of claim 2, wherein the second conductor pattern is formed such that the plurality of second antenna components are formed on the second substrate in a direction different from the direction in which the plurality of first antenna components are formed, and arranged in parallel at intervals.

4. The antenna device of claim 3, wherein the second conductor pattern is formed such that the plurality of second antenna components are arranged in parallel in a vertical direction.

5. The antenna device of claim 4, wherein each of the plurality of conductor lines connects a first end point of each of the plurality of first antenna components and a first end point of each of the plurality of second antenna components, or connects a second end point of each of the plurality of first antenna components and a second end point of another second antenna component adjacent to the second antenna component with the first end point connected.

6. The antenna device of claim 1, wherein a communication frequency of the antenna device is controlled by adjusting the number of second antenna components directly connected to each other among the second antenna components.

7. The antenna device of claim 6, wherein the communication frequency of the antenna device increases as the number of second antenna components directly connected to each other increases.

8. The antenna device of claim 1, further comprising:
a third substrate including an attachment region and a ground region,
wherein both end points of each of the plurality of second antenna components of the second substrate are attached to the attachment region.

9. The antenna device of claim 8, wherein the third substrate further comprises:
a feed point connected to one of the end points of each of the plurality of second antenna components attached to the third substrate to supply power thereto; and
a matching component pad connected to the feed point to adjust impedance.
